(19) United States
(12) Patent Application Publication
(10) Pub. No.: US 2004/0002901 A1
(43) Pub. Date: Jan. 1, 2004

(54) System for combining on-line commerce with retail stores

(76) Inventors: Robert Baker, Roseville, CA (US); Jeremy Knudsen, Farmington, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/188,353

(22) Filed: Jul. 1, 2002

(51) Int. Cl. G06F 17/60

(52) U.S. Cl. 705/26

(57) ABSTRACT

A system and method for providing an e-commerce presence for a merchant having a conventional store infrastructure, wherein the e-commerce presence is operated via a global communications network, wherein a consumer can purchase an item, then choose to pick up that item from a conventional store operated by the merchant, instead of having the item delivered, and wherein the conventional store's inventory database is managed so as to reflect the decrease in inventory at the conventional store for the on-line purchase.

### CROSS REFERENCE TO RELATED APPLICATIONS

This document incorporates by reference all of U.S. patent applicant Ser. No. 09/528,504 filed Mar. 20, 2000, and all of U.S. patent applicant Ser. No. 09/528,653 filed Mar. 20, 2000

### BACKGROUND

1. The Field of the Invention

This invention relates generally to electronic commerce via a global information network, such as the Internet. More specifically, the invention relates to a system that enables a merchant with a “brick and mortar” store to provide coordinated sales with an on-line web site via the Internet, enabling a consumer to receive goods or services purchased via the Internet by delivery, or by going to the store to pick them up.

2. Background of the Invention

The state of the art in what is considered to be on-line commerce, electronic commerce, or e-commerce, is in its infancy. Nevertheless, there are ongoing attempts to capture market share of e-commerce sales, with many merchants having gone bankrupt in the process. Yet many merchants are convinced of the profitability of the process, given the correct mix of infrastructure and support to make it work.

The types of merchants that provide e-commerce services can be divided into two different groups. Either the merchant has a brick and mortar presence (to be hereinafter referred to as a “conventional store”), and wants to add an on-line presence, or the merchant has no conventional store, and strictly provides an on-line presence. It is understandable that most of the merchants who have failed are those that relied strictly on an on-line presence.

The present invention is directed to those merchants that already have a conventional store infrastructure, and want to add to that an on-line presence. Unfortunately, there is often very little to distinguish one on-line merchant from another. Therefore, it would be an advantage over the state of the art to provide unique on-line services for a merchant with a conventional store infrastructure, to enable the merchant to improve sales and distinguish itself from competitors.

### SUMMARY OF INVENTION

It is an object of the present invention to provide a system and method that enables a merchant to combine resources associated with conventional stores with e-commerce.

It is another object to provide unique e-commerce services by enabling a consumer to purchase an item on-line, but go to a conventional store selected by the customer to pick up the purchased item.

It is another object to provide unique e-commerce services by enabling a conventional store inventory database to make the necessary modifications when items are purchased on-line, but are actually picked up by the customer from the conventional store, thereby affecting that specific store's inventory database.

In a preferred embodiment, the present invention is a system and method for providing an e-commerce presence for a merchant having a conventional store infrastructure, wherein the e-commerce presence is operated via a global communications network, wherein a consumer can purchase an item, then choose to pick up that item from a conventional store operated by the merchant, instead of having the item delivered, and wherein the conventional store's inventory database is managed so as to reflect the decrease in inventory at the conventional store for the on-line purchase.

In a first aspect of the invention, the consumer may search the inventory of a conventional store to determine if the item to be purchased is available for pick-up from the conventional store.

In a second aspect of the invention, the consumer may perform a search for an item to be purchased by pick-up from a conventional store, wherein the search parameters include the distance that the consumer is willing to travel to pick-up the item from a conventional store.

In a third aspect of the invention, the consumer may send instructions to the conventional store where the consumer will pick-up the item, the instructions including such information as the time that the item should be ready for pick-up by the consumer.

In a fourth aspect of the invention, the system and method enable the consumer to pay for the purchase on-line, or hold the item for payment at the time of pick-up at the conventional store.

These and other objects, features, advantages and alternative aspects of the present invention will become apparent to those skilled in the art from a consideration of the following detailed description taken in combination with the accompanying drawings.

### DESCRIPTION OF THE DRAWINGS

FIG. 1 is a block diagram illustrating the entire ICAM system.

FIG. 2 is a block diagram showing the default state machine of the ICAM system.

FIG. 3 is a block diagram combined with a flow chart to illustrate the ICAM search services.

FIG. 4 is a block diagram combined with a flow chart to illustrate the process of inventory verification from the web site.

FIG. 5 is a block diagram combined with a flow chart to illustrate the process of locating a product from a store inventory.

FIG. 6 is a block diagram combined with a flow chart to illustrate the process of locating a product from the customer web site.

FIG. 7 is a block diagram combined with a flow chart to illustrate the process of finding a price for a product.

FIG. 8 is a block diagram combined with a flow chart to illustrate the process of determining the sales tax for a product.

FIG. 9 is a block diagram combined with a flow chart to illustrate the process of determining product shipment routing from a specific conventional store.

FIG. 10 is a block diagram combined with a flow chart to illustrate the process of determining product shipment routing from the web site.

### DETAILED DESCRIPTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is comprises a system and method for providing an improved e-commerce experience for consumers. One of the biggest drawbacks of e-commerce is that there is always a period of at least one day between ordering and delivery. There is generally a premium delivery charge to be paid if delivery is going to be next day service. The present invention overcomes this drawback by providing a customizable system that enables any merchant with a conventional store infrastructure to integrate an on-line shopping presence with the inventories of conventional stores. Thus, the consumer can order an item on-line, such as at a web site for a merchant, and then drive to a conventional store of that merchant and pick-up the item that was just purchased. The present invention enables a merchant to take advantage of its inventory already in place at conventional stores, and make it available for searching and purchasing by on-line e-commerce consumers.

This integration of the inventory of a brick-and-mortar conventional store, and an on-line e-commerce presence is referred to throughout this document as Integrated Click-and-Mortar, or ICAM. ICAM should be thought of as Middleware, software that functions as a communications enabler as will be explained.

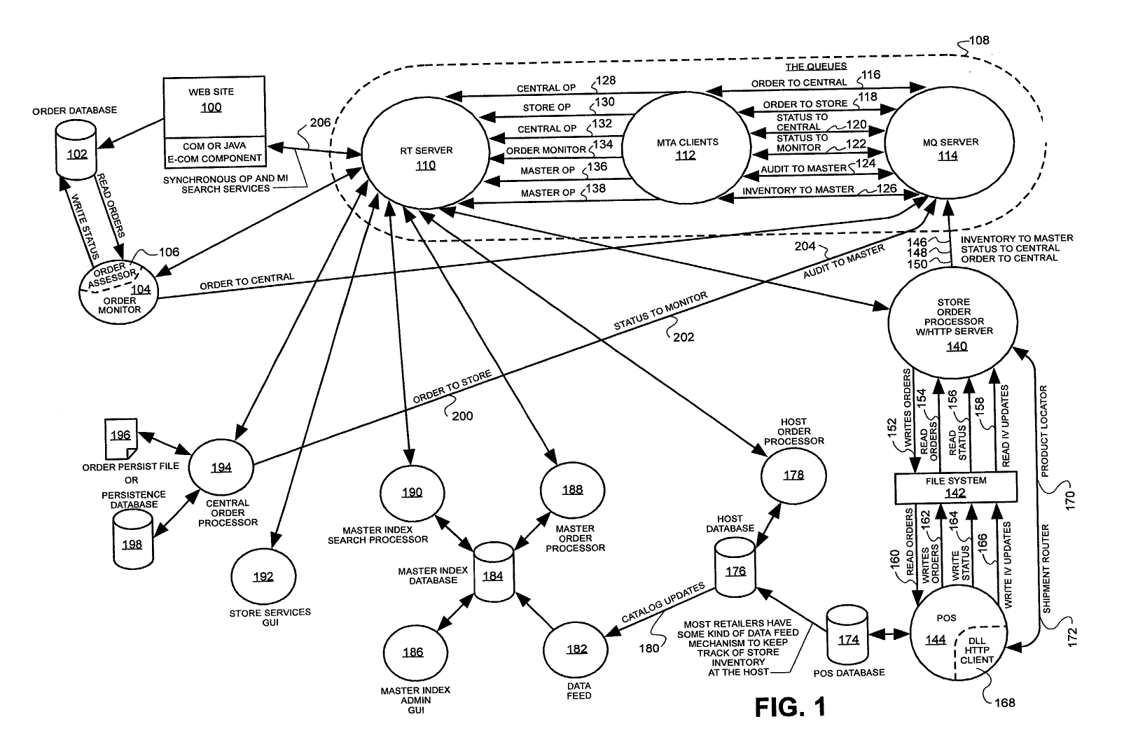

FIG. 1 is an overview or flowchart of ICAM. Beginning with the web site 100, this is the location that the consumer will visit with a web browser in order to search for products and make purchases. After deciding what product to purchase, the consumer will use the software provided by the merchant at the web site 100 to order the product. This order is transmitted to an order database 102. The order database 102 is owned by the merchant. Orders stored in the order database 102 are detected and read by the order monitor 104. The order monitor is specifically programmed for each merchant in order to operate with the merchant's order database 102. The order monitor 104 includes an order accessor 106 that informs the order monitor 104 when an order has been made by a consumer. The order monitor 104 reads the order, and is also capable of sending a status update to the order database 102. This status is generally to inform the order database 102 that the order has been received for processing.

Once the order information has been read by the order monitor 104, that information is transmitted to the messaging infrastructure 108. The message infrastructure includes an RT Server 110, the MTA clients 112, and the MQ Server 114. The order monitor 104 specifically transmits the information to the MQ Server 114. The MQ Server generates requests, such as an order to be processed, and places that request in a queue. The request remains in the queue until another process takes that request from the queue for processing.

Presently, the queues of the system include Order to Central 116, Order to Store 118, Status to Central 120, Status to Monitor 122, Audit to Master 124, and Inventory to Master 126. All of these queues are read by the MQ Server 114 and the MTA Clients 112. The MTA Clients 112 transmit information to the RT Server 110, including the Central OP (Order Processor) 128, Store OP 130, another Central OP 132, Order Monitor 134, and two Master Ops 136, 138. The RT Server 110 can either send the order to the Store Order Processor 140, or wait for the Store Order Processor to poll the RT Server 110.

The component that takes the order request from the queue of the Messaging Infrastructure 108 is the Store Order Processor 116. The function of the Store Order Processor 116 is to generate a status of the order. That status can include such things as 1) order has been submitted, 2) order has been received, 3) order has been filled, 4) order has been changed, and 5) order has been canceled.

Each of the conventional stores of the merchant has a Store Order Processor 140. When an item is purchased, the Store Order Processor 140 of the specific conventional store, from which the product is being purchased, retrieves the order from the RT Server 110. The Store Order Processor 140 then sends the order through a File System 142 to a Point Of Sale system (POS) 144. The File System 142 represents short term memory where an order is stored while being filled.

The Store Order Processor 140 maintains contact with the Messaging Infrastructure 108 by transmitting various status signals to the MQ Server 114. These status signals are inventory to master 146, status to central 148, and order to central 150.

The Store Order Processor 140 transmits or writes 152 an order to the File System 142. The File System 142 transmits status signals back to the MQ Server 114, including read orders 154, read status 156, and read IV updates 158. The File System 142 stores the order in short term memory until the File System either pushes the order information down to the POS 144, or the POS requests the order information.

The File System 142 transmits a read orders 160 signal to the POS 144. The POS 144 transmits status signals to the File System 142 including write orders 162, write status 164, and write IV updates 166.

It is noted that the Store Order Processor 140 also communicates directly with the POS 144. More specifically, the Store Order Processor 140 communicates with a dynamic link library (DLL) HTTP client 168 in the POS 144. The information exchanged includes a product locator 170 and a shipment router 172.

The POS 144 communicates with a POS database 174 that in turn communicates with a Host Database 176. The Host Database 176 is essentially the inventory database of each conventional store. The Host Database 176 also communicates with a Host Order Processor 178, and transmits catalog updates 180 to the Data Feed input 182 of a Master Index Database 184. In other words, the Master Index Database 184 is updated with the current inventory of each conventional store in order to track the inventory of all the conventional stores of the merchant.

This update would most likely take place once a day, such as at night when the system is generally going to be performing maintenance tasks. Advantageously, operation of the system is less likely to interrupt operations of the stores by performing the update when the store is not open for business. The update can take the form of only uploading changes to the Host Database 176, or a transmission of all the information stored in the Host Database 176. How often an update is performed may be a function of the size of the inventory, or a desire to have the most accurate inventory database as possible. Thus, the process of updating can be a process that occurs every second, minute, hour or whatever time parameter is desired.

The more often the update process occurs, the more accurate the searching process will be for the consumer. The tradeoff will be the system overhead in performing the updates, and transmitting the data. It will be up to the merchant to determine if the process should be real-time, or delayed. These decisions will be based upon the overall speed of the systems being used, the bandwidth available for transmission of data, and the likelihood of problems if the update is performed less often.

Merchants that do not want to perform updates too often can easily set inventory thresholds. For example, no item in inventory will be allowed to go below 50 units during an on-line purchase. This insures the merchant that there will always be at least 50 units available at the conventional store. This threshold can be adjusted for each type of goods in the inventory in order to maximize profits while minimizing the size of the total inventory.

The Master Index Database 184 includes a Master Index Administrative graphical user interface (GUI) 186, a Master Order Processor 188, and a Master Index Search Processor 190. The function of the Master Index Administrative GUI 186 is to provide an interface for a system administrator who is controlling and programming the functions of the Master Index Database 184. The function of the Master Order Processor 188 is to synchronize the information held in the Master Index Database 184, and the temporary information being stored by the Messaging Infrastructure 108. Finally, the function of the Master Index Search Processor 190 is to provide the interface and other functions that enable the Master Index Database 184 to be searched for goods.

When a consumer performs a search of inventory that is available at a conventional store, that inventory information is taken from a database associated with the Host Order Processor 178, the Store Order Processor 140, or the Master Order Processor 188. The choice is left to the Merchant to decide which database to use. Note that the Order Processor and Master Index searching are synchronous services 206. The search data is transmitted from the RT Server 110 to the Web Site 100 as search result information is retrieved from the Host Database 176, the Master Index Database 184, or the POS Database 174, depending upon the merchant's selection.

Note the various elements of the system that communicate directly with the RT Server 110 of the Messaging Infrastructure 108. These components include the Store Order Processor 140, the Host Order Processor 178, the Master Order Processor 188, and the Master Index Search Processor 190, thereby keeping the Messaging Infrastructure well informed of the progress of the transaction being performed.

Two processes not yet described are processes the communicate directly with the RT Server 110 of the Messaging Infrastructure 108. The first process is referred to as the Store Services GUI 192.

The second process is the Central Order Processor 194. The Central Order Processor utilizes an order persist file 196 or a Persistence Database 198 for data storage. The function of the Central Order Processor 194 is to determine, when an order is made at the web site 100, which conventional store the consumer will visit to actually make the purchase. Thus, once the conventional store has been chosen, the Store Order Processor 140 of that conventional store will be notified of the order by the RT Server 110. The Central Order Processor 194 communicates with the MQ Server 114 of the Messaging Infrastructure 108 by sending an order to store 200, a status to monitor 202, or an audit to master 204 signal. The order to store signal 200 identifies the conventional store that should receiver the order.

There are various options that the consumer can select when making a purchase on-line using the present invention. For example, suppose that the consumer has found the item that is to be purchased. The consumer can choose the option of having the system show which stores carry the item, regardless of its availability in the current inventory, if there is more than one store in the area that the consumer might visit. The consumer can also choose to have the system show all the stores that carry the item and also have the item in stock.

The search parameters that are used by the system to determine the location of conventional stores that are near to the consumer include a zip code and a radius. For example, the consumer can provide a zip code and specify that only stores within that zip code be shown. The consumer can also specify the zip code, and request that any conventional stores within a particular radius of that zip code also be shown. These search parameters should not be considered limiting. For example, the consumer might also specify an actual address, and a radius around that address that should be defined as the area in which conventional stores should be searched for the item to be purchased.

Suppose that a consumer has made an order, the Central Order Processor 194 has selected a conventional store, and the Store Order Processor 104 of that conventional store was notified of the order. A sales person is notified by the POS 144 of the conventional store that an item is to be picked (taken from the shelves and set aside for pick-up). The sales person can send a status signal back to the Central Order Processor 194 that the item has been picked. The Central Order Processor 194 sends a status to monitor 202 signal to the MQ Server 114, which then sends that status back to the Order Monitor 104. The Order Accessor 106 puts that data into the Order Database 102. The consumer can then periodically check on the status of the order to determine when it is ready to be picked up, or the system can generate a message, such as an e-mail, that is transmitted to the consumer.

In an alternate embodiment, the POS 144 or the Store Order Processor 140 can be set up to generate the e-mail message to the consumer regarding the updated status of the order. The decision to enable the merchant or the ICAM system to generate the message is up to the merchant.

One of the advantages of the preferred embodiment is store allocation. If a sale is made on-line and the item purchased is shipped from a warehouse, it is not realistic to allocate a sale to a particular conventional store. This can make it difficult to determine sales on a store-by-store basis. The present invention makes it possible to allocate all on-line sales to conventional stores whenever the consumer chooses to pick up the item purchased from a store.

One of the most significant advantages of the invention is the ability to draw the consumer into a store. Impulse buying is a very important aspect of retail sales. The ability to bring a consumer to a store can have a significant impact on yearly sales.

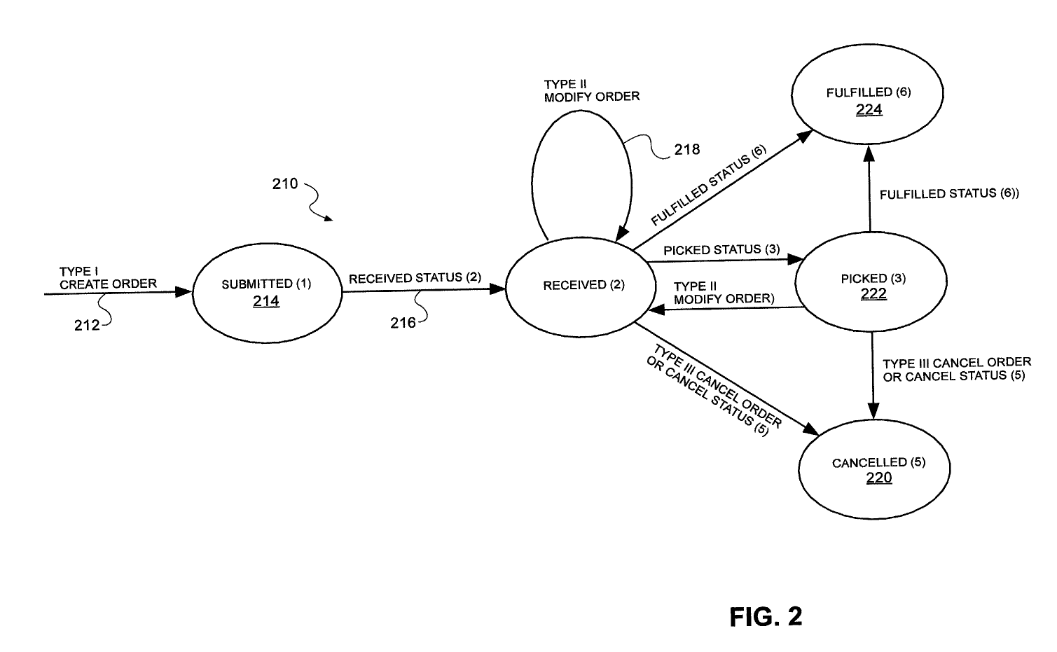

FIG. 2 is provided as a diagram that shows the operation of the Central Order Processor 194. Operation of the Central Order Processor 194 is controlled by a state machine. It is noted that the state machine defined in FIG. 2 is only illustrative of the functions that can be performed by the Central Order Processor 194. The functions can be changed to suit the preferences of the merchant.

While FIG. 1 shows the detail of the overall ICAM system, the state machine diagram of FIG. 2 illustrates the functional flow of the ICAM process. The flowchart describes the default state machine. One of the advantageous aspects of the invention is that a merchant can modify this state machine and define the transitions and actions associated with those transitions.

The default state machine 210 begins with the creation of an order 212 that is submitted 214 to the ICAM system. The state machine 210 sends a received status signal 216 after the order has been received 208. A user has several options at this stage. The user can first modify the order 218 before moving forward in the state machine 210. At this point, two things can happen. The order is either canceled 220, or is picked 222 from inventory at the conventional store. If picked 222, the order is then fulfilled 224.

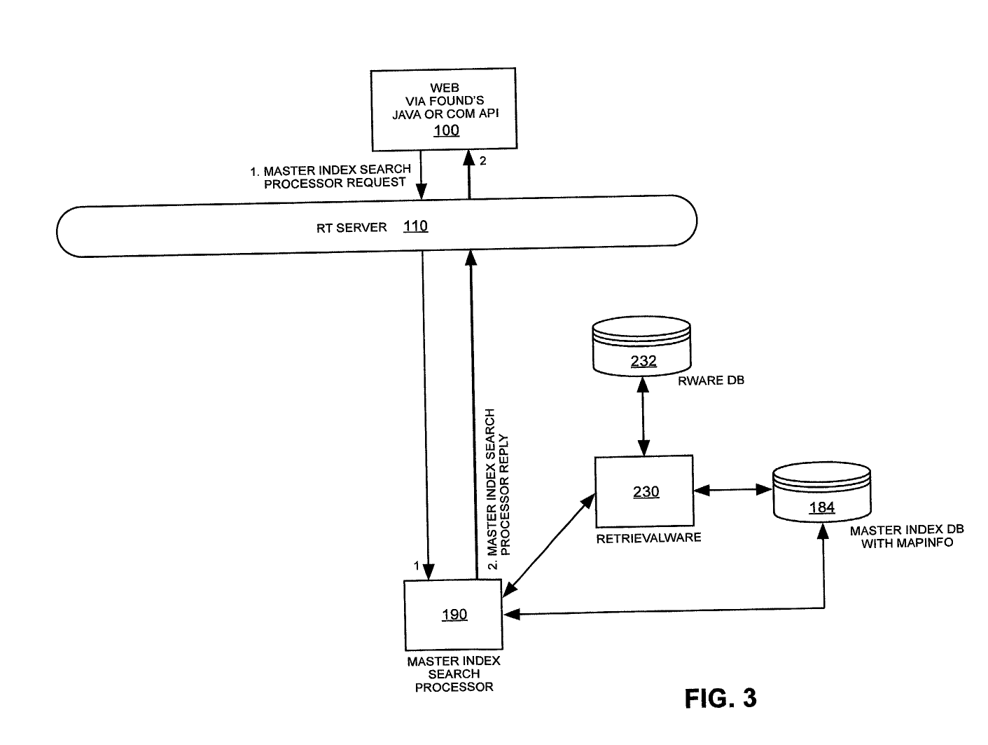

The following eight figures are provided to illustrate the ICAM search services. Beginning with FIG. 3, these search services are all connected to the RT Server 110 from FIG. 1. The user is going to be utilizing the web 100 to access a database of products. A search request is submitted by way of a Master Index Search Processor Request through the RT Server 110 to the Master Index Search Processor 190. The Master Index Search Processor 190 uses RetrievalWare 230 to query the Master Index database 184 and a RetrievalWare database 232. When the desired information is retrieved, a Master Index Search Processor Reply signal is sent back to the customer on the web site 100 through the RT Server 110. The presently preferred embodiment of the ICAM system enables a localized search of specific stores or store, an outlet locator, an item search, an SKU search, a product filter, a category browse feature, and a product browser.

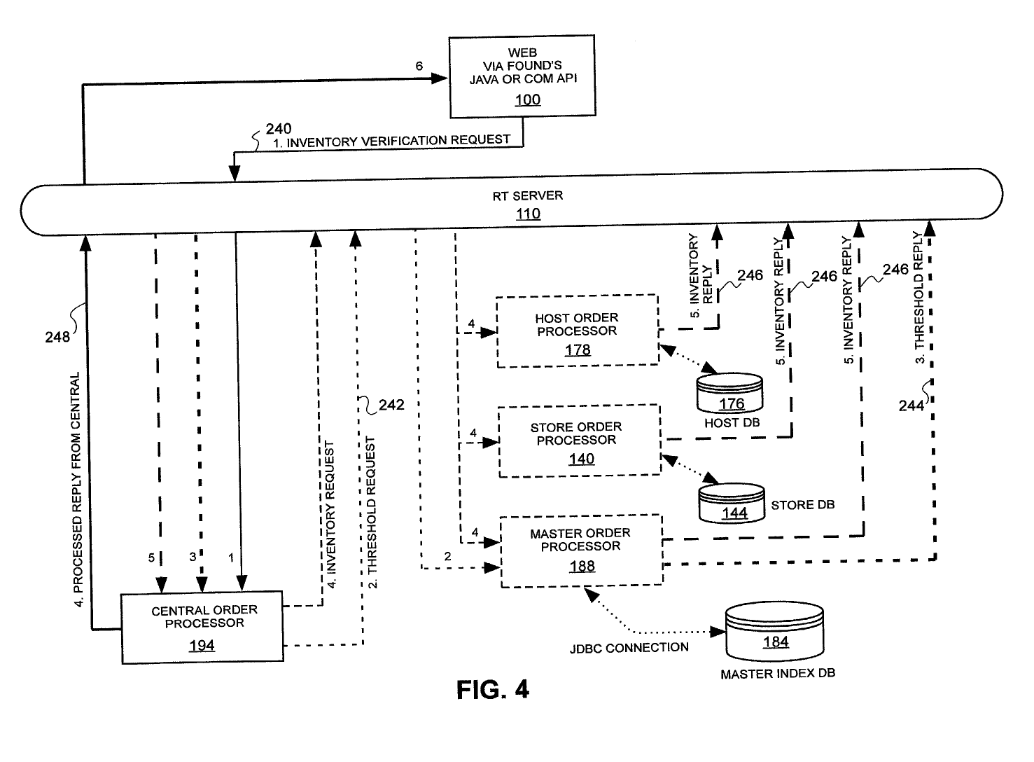

FIG. 4 shows the process whereby inventory verification is performed. The web site 100 generates an Inventory Verification Request signal 240, which is sent through the RT Server 110 to the Central Order Processor 194. The Central Order processor 194 generates a Threshold Request signal 242 that passes through the RT Server 110 on its way to the Master Order Processor 188, which generates a Threshold Reply signal 244 that goes back to the RT Server 110. The RT Server 110 then queries either the Host Order Processor 178, the Store Order Processor 140, or the Master Order Processor 188. Only one of these processors will be configured to verify inventory. That decision is made by the merchant. Each of these processors would consults its associated database 176, 144, or 184, and generate an Inventory Reply signal 246 that is sent through the RT Server 110 to the Central Order Processor 194. A Processed Reply from Central signal 248 is then sent back through the RT Server 110 to the web site 100.

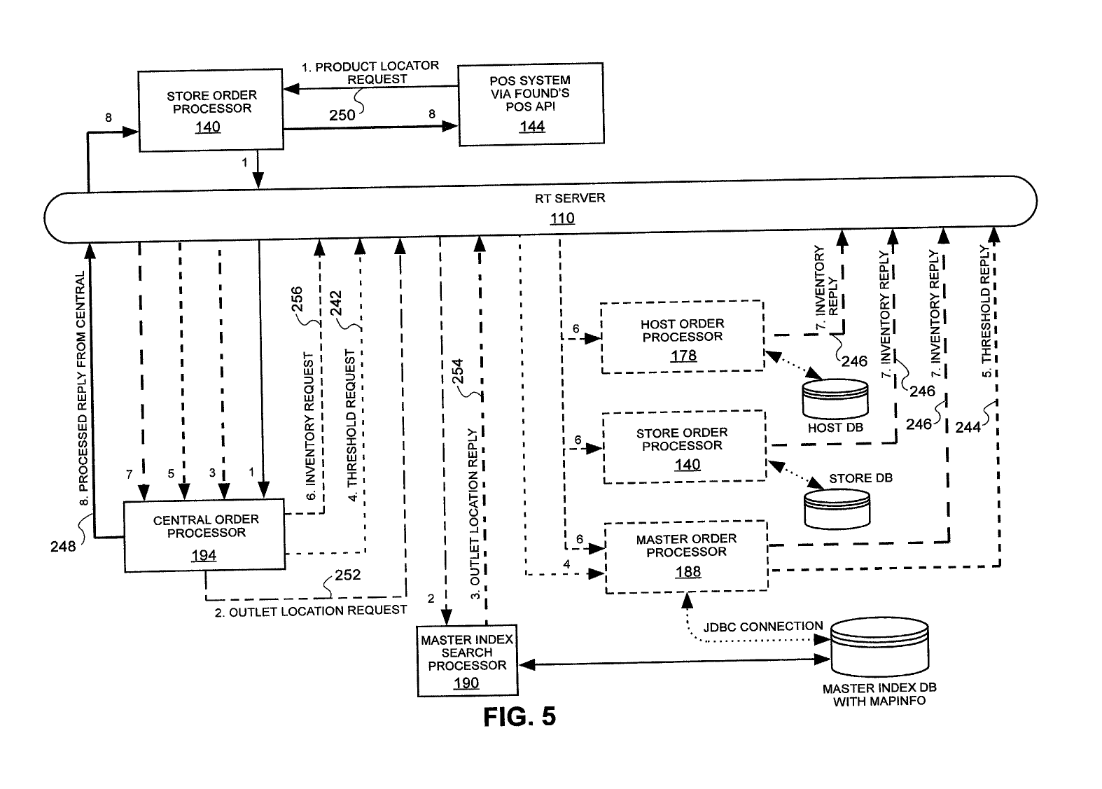

FIG. 5 illustrates the process whereby ICAM locates a product at a particular conventional store from the store itself. A Product Locator Request signal 250 is generated by a conventional store's Point of Sale system 144, and sent to the Store Order Processor 140. The signal is passed through the RT Server 110 to the Central Order Processor 194, which generates an Outlet Location Request signal 252 which is sent to the Master Index Search Processor 190. An Outlet Location Reply signal 254 is generated and sent back to the Central Order Processor 194. A Threshold Request signal 242 is sent to the Master Order Processor 188, which generates the Threshold Reply signal 244 that goes back to the Central Order Processor 194.

An Inventory Request signal 256 will be sent to either the Host Order Processor 178, the Store Order Processor 140, or the Master Order Processor 188. Only one of these processors will be configured to verify inventory. That decision is made by the merchant. Each of these processors would consults its associated database 176, 144, or 184, and generate an Inventory Reply signal 246 that is sent through the RT Server 110 to the Central Order Processor 194. The Processed Reply signal 248 is then sent back to the Store Order Processor 140, and then to the POS 144.

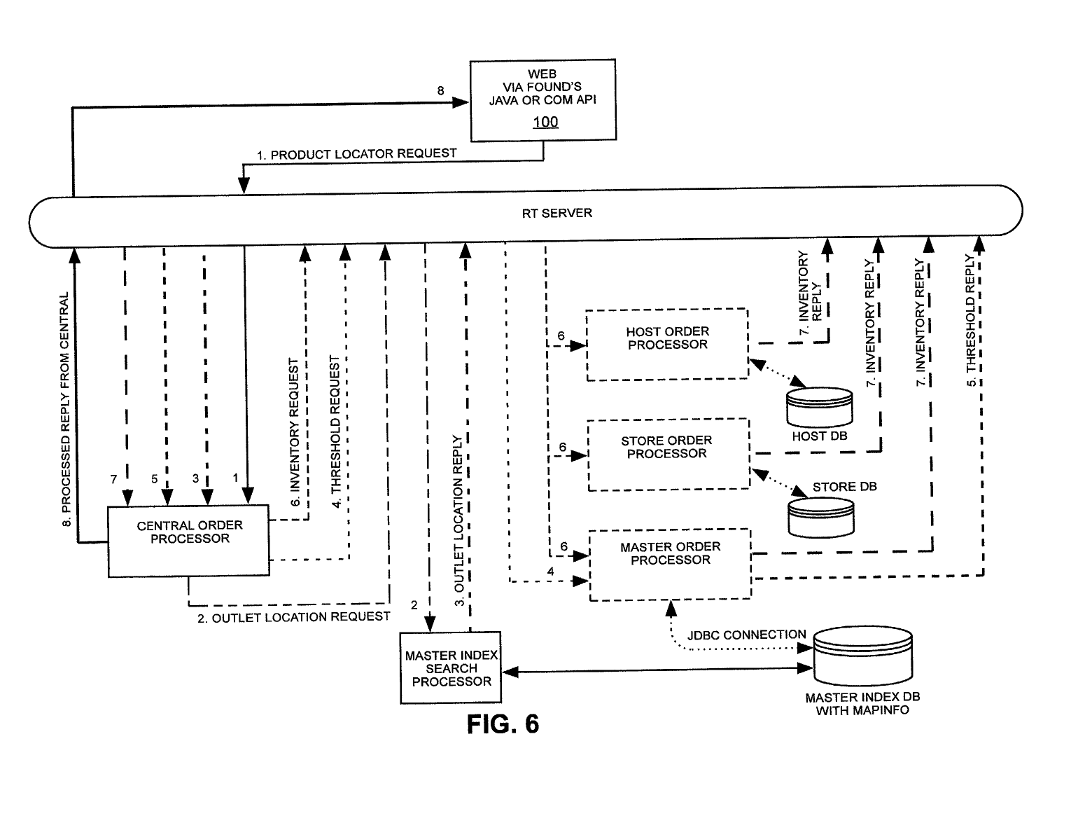

FIG. 6 illustrates how the ICAM system performs a product locator search from a request that is generated from the web site 100. This process is identical to that shown in FIG. 5, with the exception that the web site 100 is generating the product search instead of the POS 144.

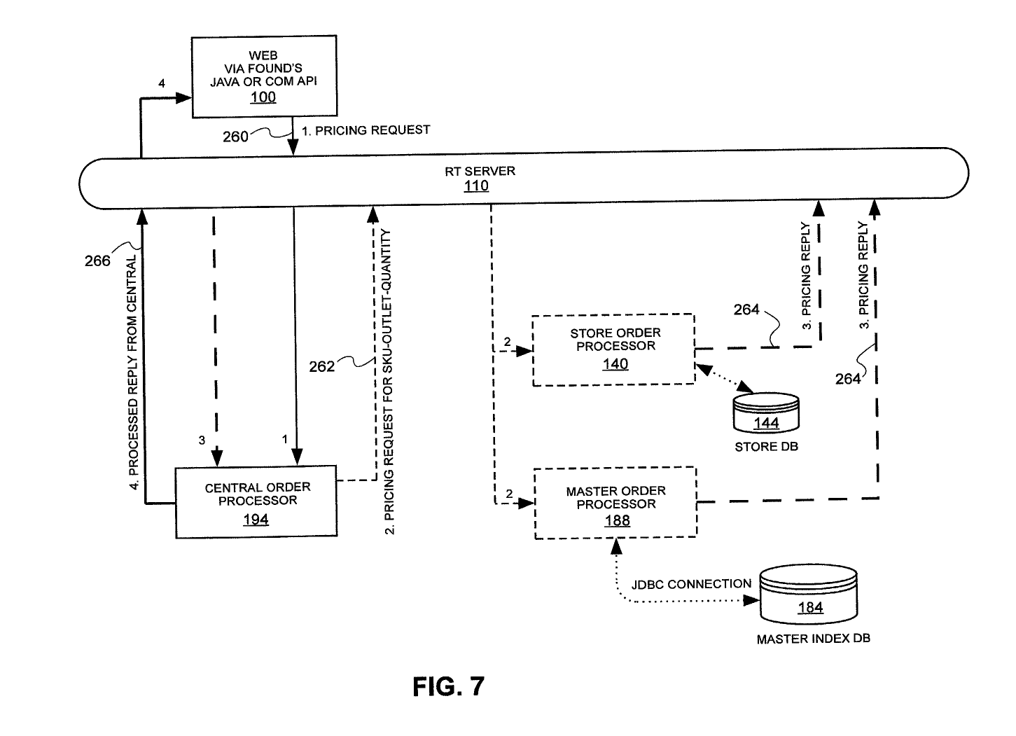

FIG. 7 illustrates how the ICAM system performs a pricing search from the web site 100. When the customer wants pricing information, the web site 100 generates a Pricing Request signal 260 that is sent to the Central Order Processor 194. A Pricing Request for SKU-Outlet-Quantity signal 262 is sent to either the Store Order Processor 140 or the Master Order Processor 188. This choice is up to the merchant. A Pricing Reply 264 is sent back to the Central Order Processor 194 which generates the Processed Reply from Central 266 that is sent back to the web site 100.

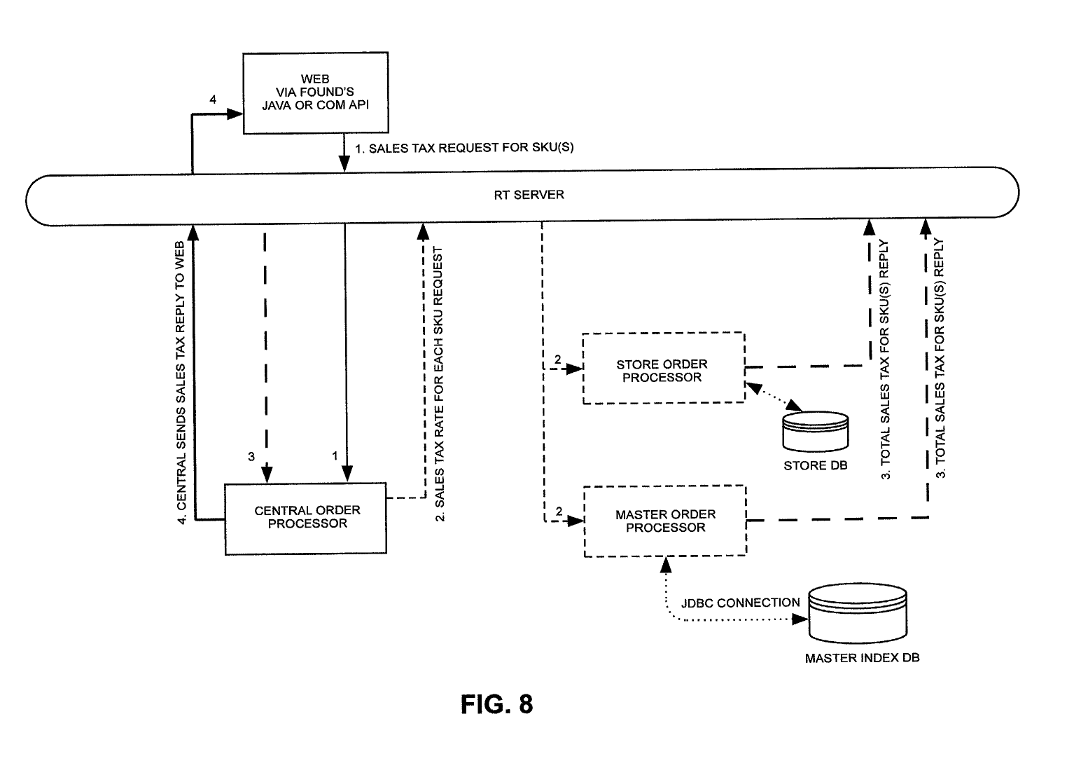

FIG. 8 illustrate how the ICAM system performs a sales tax calculation. This process is identical to the pricing search shown in FIG. 7, with the requested information pertaining to sales tax instead of pricing.

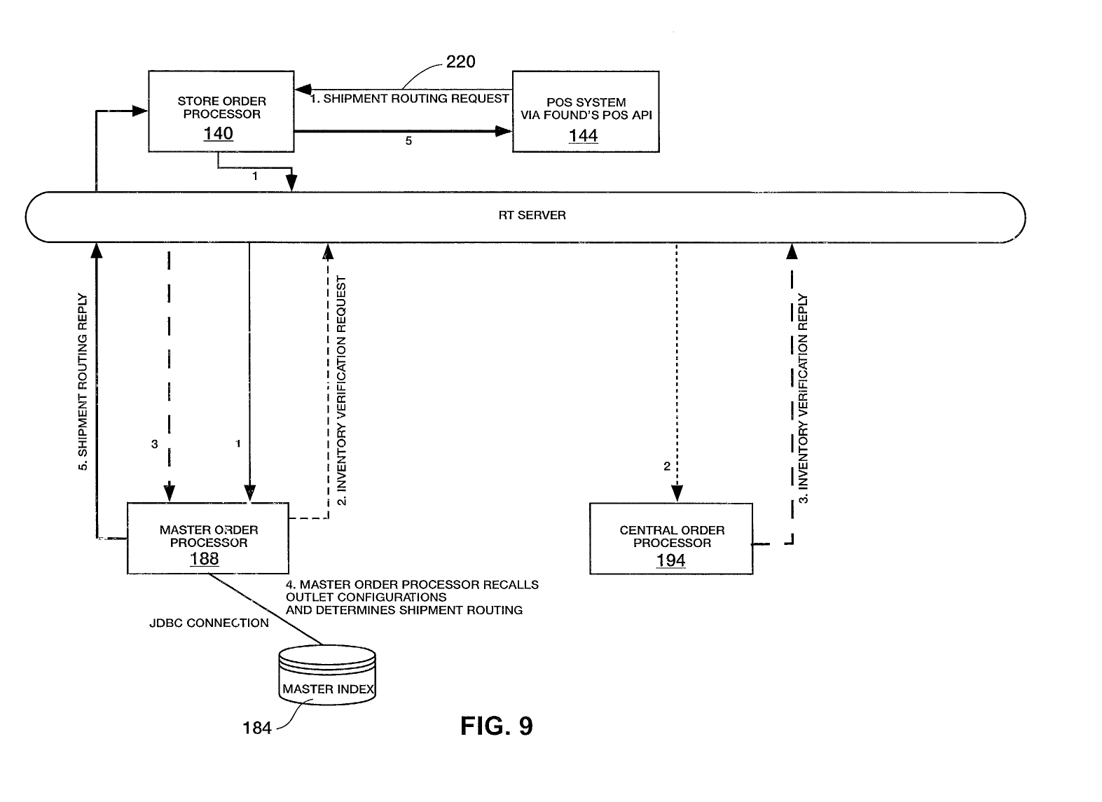

FIG. 9 illustrates how the ICAM system performs Shipment Routing from a conventional store. The POS 144 generates a Shipment Routing Request signal 270 that goes to the Store Order Processor 140, and then to the Master Order Processor 188. Inventory verification is confirmed by the Central Order Processor 194. The Master Order Processor 188 then consults the Master Index database 184 and recalls outlet configurations and determines shipment routing when shipment is going to take place from a conventional store and not a warehouse. This information is then sent to the POS 144.

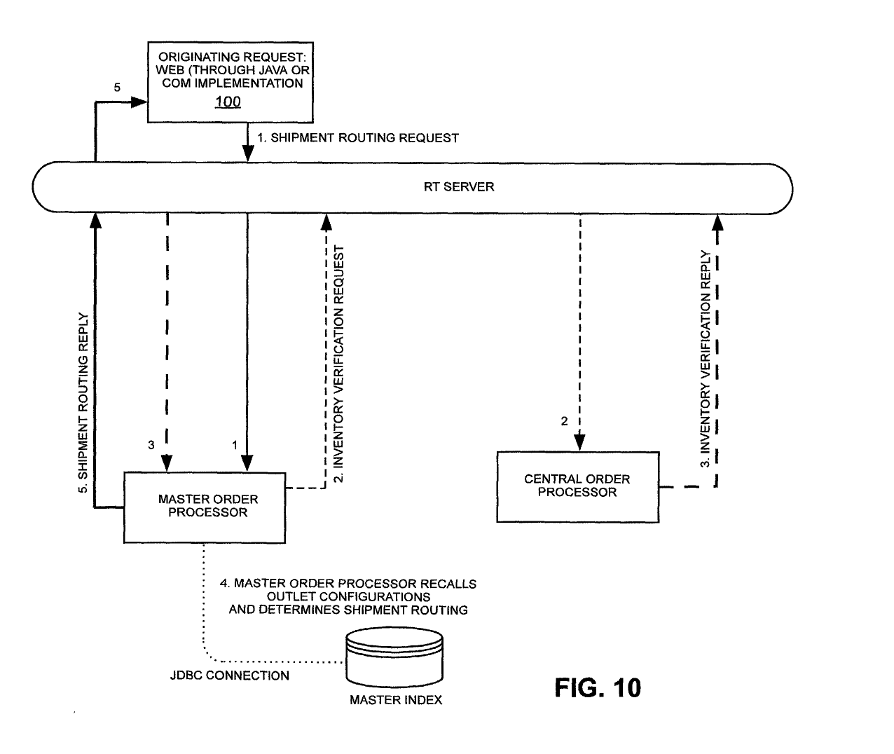

FIG. 10 illustrates how the ICAM system performs Shipment Routing from the web site 100. The process is essentially identical to the process taught in FIG. 9, except that the Shipment Routing Request comes from the web site 100, and not the POS 144.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for providing on-line purchasing of products that are retrieved by a consumer from a conventional store, the method comprising the steps of:
(1) integrating inventory of a plurality of conventional stores with an on-line site where purchases can be made by the consumer;
(2) enabling the consumer to select at least one product from the on-line site;
(3) identifying a geographic location near which the consumer desires to pick up the at least one product;
(4) providing a list of the plurality of conventional stores that are within a selectable distance of the geographic location;
(5) enabling the consumer to select one of the plurality of conventional stores from the list where the at least one product will be held for the consumer;
(6) enabling the consumer to complete a purchase of the at least one product at the on-line site; and
(7) modifying the inventory of the selected one of the plurality of conventional stores to reflect the purchase made by the consumer.

2. The method as defined in claim 1 wherein the method further comprises the steps of:
(1) providing a Messaging Infrastructure for controlling operation of the inventory integration, wherein the Messaging Infrastructure is operated at a first site;
(2) providing a web site on the world wide web as the on-line site where the consumer makes a purchase, wherein the web site is operated at a second site; and
(3) synchronizing order purchase and master index search services between the Messaging Infrastructure and the web site.

3. The method as defined in claim 2 wherein the method further comprises the steps of:
(1) providing an order database that receives order information from the web site;
(2) transmitting an order from the order database to an order monitor, wherein the order monitor can provide a status update to the order database; and
(3) transmitting the order from the order monitor to the messaging infrastructure to enable processing of the orders.

4. The method as defined in claim 3 wherein the method further comprises the steps of:
(1) queueing the order received from the order monitor at the messaging infrastructure, wherein the queues include Order to Central, Order to Store, Status to Central, Status to Monitor, Audit to Master, and Inventory to Master; and
(2) transmitting the order from the messaging infrastructure to a Store Order Processor, wherein the Store Order Processor can poll for orders, or receive orders sent by the messaging infrastructure.

5. The method as defined in claim 4 wherein the method further comprises the step of providing a plurality of Store Order Processors, one for each of the plurality of conventional stores.

6. The method as defined in claim 5 wherein the method further comprises the step of generating a status of the order by the Store Order Processor, wherein the status includes a) order has been submitted, b) order has been received, c) order has been filled, and d) order has been canceled.

7. The method as defined in claim 6 wherein the method further comprises the steps of:
(1) transmitting the order from the Store Order Processor to a File System;
(2) transmitting the order from the File System to a Point of Sale system (POS); and
(3) wherein the File System is short term memory for holding an order while the order is being filled, and wherein the POS can request the order, or the File System can send the order to the POS without the order being requested.

8. The method as defined in claim 7 wherein the method further comprises the steps of:
(1) transmitting status information from the web site to the consumer;
(2) transmitting status information from the Messaging Infrastructure to the web site;
(3) transmitting status information from the Store Order Processor to the Messaging Infrastructure;
(4) transmitting status information from the File System to the Store Order Processor; and
(5) transmitting status information from the POS to the File System, wherein transmission of status information enables the consumer to be apprized of progress of the order.

9. The method as defined in claim 8 wherein the method further comprises the steps of:
(1) providing a Master Index Database in order to keep track of the inventory located at the plurality of conventional stores; and
(2) providing a Host Database at each of the plurality of conventional stores, wherein the Host Database updates the Master Index Database at specified intervals, wherein the Host Database is updated by the POS.

10. The method as defined in claim 9 wherein the method further comprises the steps of:
(1) providing a Master Order Processor for communicating information regarding orders between the Messaging Infrastructure and the Master Index Database, wherein the Master Order Processor performs the function of synchronizing information in the Master Index Database with temporary being stored by the Messaging Infrastructure;
(2) providing a Master Index Search Processor for communicating information regarding product searches between the Messaging Infrastructure and the Master Index Database, wherein the Master Index Search Processor enables the Master Index Database to be searched for products;
(3) providing a Master Index Administrative Interface to the Master Index Database in order to perform administrative tasks; and
(4) providing a Data Feed between the Host Database and the Master Index Database in order to receive inventory updates.

11. The method as defined in claim 10 wherein the method further comprises the steps of:
(1) updating the Master Index Database with inventory information from the Host Database at a selectable interval;
(2) transmitting inventory information in the form of changes made to inventory in the Host Database.

12. The method as defined in claim 10 wherein the method further comprises the steps of:
(1) updating the Master Index Database with inventory information from the Host Database at a selectable interval; and
(2) transmitting inventory information in the form of a complete copy of the Host Database.

13. The method as defined in claim 10 wherein the method further comprises the step of selecting a method of updating the Master Index Database by balancing overhead demands on the system versus accuracy of inventory information.

14. The method as defined in claim 13 wherein the method further comprises the steps of:
(1) setting an inventory threshold for each product in inventory that is available for on-line purchase at the web site;
(2) monitoring inventory; and
(3) removing a product from the web site as available for purchase whenever inventory of the product drops below the inventory threshold for that product.

15. The method as defined in claim 14 wherein the method further comprises the step of enabling each of the plurality of conventional stores to set a unique inventory threshold for each of the products available for on-line purchase, to thereby minimize inventory while maximizing profitability.

16. The method as defined in claim 15 wherein the method further comprises the steps of:
(1) determining which of the plurality of conventional stores is selected by the consumer where the consumer will go to pick up the purchased product; and
(2) utilizing an Order Persist File or a Persistence Database to record this information.

17. The method as defined in claim 16 wherein the method further comprises the step of providing options to the consumer regarding how to select which of the plurality of conventional stores to visit to pick up the purchased product.

18. The method as defined in claim 17 wherein the method further comprises the step of providing a list of conventional stores that carry a desired product, regardless of availability of the desired product.

19. The method as defined in claim 18 wherein the method further comprises the step of providing a list of conventional stores that carry the desired product and currently have the product in inventory.

20. The method as defined in claim 19 wherein the method further comprises the step of providing a list of conventional stores that are located within a specific geographical region as defined by zip code, city, state, or radius around a specific zip code.

21. The method as defined in claim 20 wherein the method further comprises the steps of:
(1) notifying a sales person at a selected conventional store utilizing the POS that a product has been selected for purchase and pickup by the consumer;
(2) picking the product from inventory; and
(3) sending a status message to the Messaging Infrastructure that the product has been picked.

22. The method as defined in claim 21 wherein the method further comprises the steps of:
(1) generating a message to the consumer that the product is ready for pick up at the selected conventional store; and
(2) transmitting the message to the consumer via e-mail or an update to a web page that is accessible by the consumer.

23. The method as defined in claim 22 wherein the method further comprises the step of allocating a sale to a specific conventional store when an on-line purchase is performed and a product is picked up from the specific conventional store, to thereby more accurately determine sales for each of the plurality of conventional stores.

24. A method for providing on-line purchasing of products that are delivered to a consumer from a conventional store, the method comprising the steps of:
(1) integrating inventory of a plurality of conventional stores with an on-line site where purchases can be made by the consumer;
(2) enabling the consumer to select at least one product from the on-line site;
(3) identifying a geographic location near which the consumer desires the at least one product be delivered from;
(4) providing a list of the plurality of conventional stores that are within a selectable distance of the geographic location;
(5) enabling the consumer to select one of the plurality of conventional stores from the list from which the at least one product will be delivered to the consumer;
(6) enabling the consumer to complete a purchase of the at least one product at the on-line site; and
(7) modifying the inventory of the selected one of the plurality of conventional stores to reflect the purchase made by and delivered to the consumer.

25. A method for coordinating sales from an on-line purchase with inventory at a conventional store, the method comprising the steps of:
(1) providing on-line purchasing of a product at a web site; and
(2) enabling a consumer to pick up the product purchased on-line at a conventional store selected by the consumer.

26. The method as defined in claim 25 wherein the method further comprises the steps of:
(1) providing a Master Index Database that includes inventory from a plurality of conventional stores; and
(2) enabling the consumer to purchase products that are listed in the inventory.

27. The method as defined in claim 26 wherein the method further comprises the steps of:
(1) receiving updated inventory lists from the plurality of conventional stores at the Master Index Database, to thereby provide an accurate inventory to the on-line consumer; and
(2) updating the Master Index Database at a selectable rate in order to balance the interests of overhead versus accuracy of the Master Index Database.

28. The method as defined in claim 27 wherein the method further comprises the steps of providing options to the consumer regarding how to select which of the plurality of conventional stores to visit to pick up the purchased product.

29. The method as defined in claim 28 wherein the method further comprises the step of providing a list of conventional stores that carry a desired product, regardless of availability of the desired product.

30. The method as defined in claim 28 wherein the method further comprises the step of providing a list of conventional stores that carry the desired product and currently have the product in inventory.

31. The method as defined in claim 28 wherein the method further comprises the step of providing a list of conventional stores that are located within a specific geographical region as defined by zip code, city, state, or radius around a specific zip code.
